(19) United States
(12) Patent Application Publication
(10) Pub. No.: US 2025/0136350 A1
(43) Pub. Date: May 1, 2025

(54) THERMALLY INSULATING PACKAGING ASSEMBLY

(71) Applicant: Hazen Paper Company, Holyoke, MA (US)

(72) Inventors: John Hazen, South Hadley, MA (US); Don Harvourd, Ellington, CT (US)

(73) Assignee: Hazen Paper Company, Holyoke, MA (US)

(21) Appl. No.: 18/918,490

(22) Filed: Oct. 17, 2024

Related U.S. Application Data
(60) Provisional application No. 63/593,348, filed on Oct. 26, 2023.

(51) Int. Cl. B65D 81/38; B32B 15/12; B32B 15/20; B32B 37/00; B32B 37/24; B65D 65/42; B65D 81/30

(52) U.S. Cl. CPC B65D 81/3823; B32B 15/12; B32B 15/20; B32B 37/025; B32B 37/24; B65D 65/42; B65D 81/30; B32B 2037/243; B32B 2255/06; B32B 2255/26; B32B 2307/304; B32B 2307/306; B32B 2311/24; B32B 2317/12

(57) ABSTRACT

A thermally-insulating packaging assembly includes an enclosure having a plurality of walls defining an interior volume therebetween for receiving a plurality of beverage containers. Each of the plurality of walls includes a substrate, an adhesive layer, and a metallized layer coupled to the substrate via the adhesive layer.

### CROSS-REFERENCE TO RELATED APPLICATIONS

This application claims priority to U.S. Provisional Application No. 63/593,348, filed on Oct. 26, 2023, the entire disclosure of which is incorporated herein by reference.

### FIELD OF THE INVENTION

This invention relates generally to packaging and, more particularly, to a thermally insulating packaging assembly for beverage containers.

### BACKGROUND

Beverage containers such as glass bottles and aluminum cans are used to hold many types of beverages such as carbonated soft drinks, fruit drinks, and beer. These types of beverages, in addition to being offered for individual retail sale, are often packaged together in 6, 8, 12, 24, 30 or 36 unit packages, typically cardboard or paperboard boxes. These boxes are often transported, stored and offered for sale in a refrigerated state.

When the paperboard box of beverages is removed from the chilled environment, however, the beverages begin to quickly warm due to a combination of external heat sources including ambient heat of the surrounding environment, contact with warm surfaces such as the consumer's hand or the surface on which the container is placed, as well as radiant heat from the sun or other light sources. Heat transfer takes place through the walls, base, and top of the box to the beverage. Without some means provided for insulating the container, or rapid transfer to another refrigerated environment, the beverages warm so quickly that, in many circumstances, they becomes undesirable or unfit for consumption and/or must be refrigerated once again to achieve an optimal consumption temperature.

In view of the above, there is a need for a thermally insulating packaging assembly that maintains packaged beverages at low temperatures and/or reduces heat transfer from the ambient environment to the packaged beverages.

### SUMMARY OF THE INVENTION

It is an object of the present invention to provide a packaging assembly.

It is another object of the present invention to provide a packaging assembly for food items.

It is another object of the present invention to provide a packaging assembly for beverages.

It is another objected of the present invention to provide a packaging assembly that minimizes heat transfer to packaged products.

These and other objects are achieved by the present invention.

According to an embodiment of the present invention, a thermally-insulating packaging assembly is provided that includes an enclosure having a plurality of walls defining an interior volume therebetween for receiving a plurality of beverage containers. Each of the plurality of walls includes a substrate, an adhesive layer, and a metallized layer coupled to the substrate via the adhesive layer.

In accordance with one embodiment, a multi-layered packaging assembly is provided that includes a plurality of walls arranged to define an interior space. At least one of the plurality of interior walls includes a base layer, an insulating adhesive layer disposed atop the base layer, a metallized layer coupled to the base layer via the insulating adhesive layer, and a heat-resistant coating layer disposed atop the metallized layer.

In accordance with another embodiment, a method of forming a multi-layered packaging assembly is provided that includes providing a substrate, depositing an adhesive layer on the substrate, depositing a metallized layer on the adhesive layer. The substrate, the adhesive layer, and the metallized layer forming a layered assembly. The method may include forming the layered assembly into an enclosure having an interior volume for receiving a plurality of beverage containers.

### BRIEF DESCRIPTION OF THE DRAWINGS

FIG. 1 is a schematic illustration of a packaging construction according to one embodiment of the present invention.

FIG. 2 is a schematic illustration of a packaging construction according to another embodiment of the present invention.

FIG. 3 is a perspective view of a packaging assembly, according to one example.

FIG. 4 shows a flowchart illustrating one example of a method for forming a multi-layer packaging assembly.

### DETAILED DESCRIPTION OF THE PREFERRED EMBODIMENT

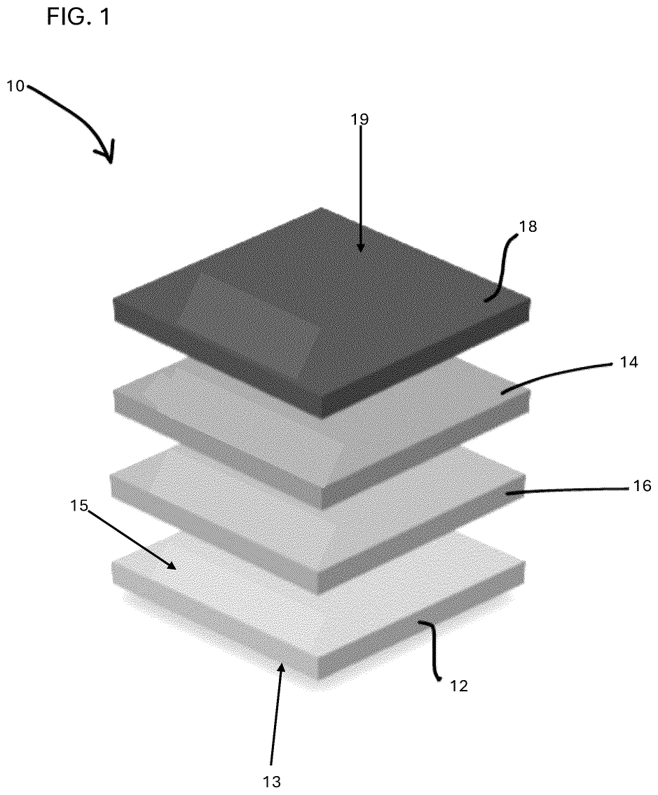

With reference to FIG. 1, a packaging construction 10 of a packaging assembly according to an embodiment of the present invention is illustrated. As shown in FIG. 1, the packaging construction 10 includes a base layer or substrate 12 having a first side 13 configured to form an interior surface of a packaging assembly. A metallized layer 14 may be joined to an outside facing surface 15 of the base layer 12 by an adhesive layer 16. In one embodiment, a printable coating 18 is positioned adjacent to the metallized layer 14 and forms an outermost layer/surface 19 of the packaging assembly. As will be appreciated, the layers shown in FIG. 1 are not drawn to scale and sizes are exaggerated to better illustrate component parts.

The first side 13 of the base layer 12 may be configured to form an inner layer of the packaging assembly. The packaging construction 10 may form an enclosure having a plurality of walls made from the substrate, adhesive, metallized layer, and/or the printable coating layer. The first side 13 may define an interior volume of the packaging assembly, as discussed further below.

In an embodiment, the base layer 12 is a paperboard or cardboard substrate, although other materials known in the art such as polyester, vinyl and the like may also be utilized without departing from the broader aspects of the invention. As will be appreciated by one of ordinary skill, the base layer 12 may be made of any material without departing from the broader aspects of the present invention. The base layer 12 may be made of materials of various weights, thicknesses, and surface finishes.

In an embodiment, the adhesive layer 16 is a thermally-insulating adhesive having thermal insulating properties, although any adhesive known in the art may also be utilized even if it does not provide insulating properties (although insulating properties are desirable). The adhesive layer 16 may be heat activated, optically activated (e.g., UV light cured); or configured for attachment to the base layer 12 by mechanical means (e.g., “knurled” or textured together; or, flowing and freezing into textured surface crevices). The adhesive may be applied at a desired viscosity and/or pattern based on the desired use characteristics. The adhesive may be applied in a unique pattern to the substrate, and an additional layer (e.g., the metallized layer) may be applied to couple the substrate to the additional layer.

The metallized layer 14 and/or the printable coating 18 may form the outermost layer/surface 19 of the packaging assembly. The printable coating may contain images or graphics that are printed or otherwise deposited thereon (e.g., a metallized, embossed holographic structure). In one example, the printable coating 18 may be a heat-resistant coating layer that may further insulate the interior volume of the packaging assembly.

The printable coating 18 may be formed from colorless polymers including, but not limited to, acrylic, polyester, polypropylene, polyethylene, polyethylene terephthalate, polyvinyl chloride and polyurethane polymers, nitrocellulose, and the like, and combinations thereof. In an exemplary embodiment, the coating 18 is formed using one or more heat stable amorphous or semi-crystalline polymers (e.g., acrylic, polyester and polyurethane polymers) having a T_{g} of greater than or equal to about 85° C., such as poly (methyl methacrylate) or PMMA and has a thickness of greater than or equal to 0.8 microns (preferably, from about 0.8 to about 4.0 microns). Such heat stable PMMA materials are available from Sun Chemical Corporation, 35 Waterview Boulevard, Parsippany, N.J. 07054-1285. In one example, the coating may be deposited directly atop the metallized layer through the use of a spray applicator or liquid coating.

In some embodiments, the metallized layer 14 may be a reflective metallized layer that may reflect light away from an interior volume of the packaging assembly. The metallized layer 14 may be the exterior most layer and may be positioned to reflect light from the packaging assembly. With respect to the metallized layer 14, such layer may be a vacuum metallized reflective layer, e.g., an aluminum vacuum metallized reflective layer. In an embodiment, the metallized reflective layer 14 may be applied to the substrate 12 using any technique known in the art, such as transfer lamination and the like.

Transfer lamination is a process by which a layer of material is applied to a substrate. Generally, transfer lamination involves bonding a transfer film having an application layer, e.g., a metallized layer, to a paper substrate, stripping the film from the substrate leaving the application layer, and then applying a coating to the layer to facilitate printing. As will be appreciated, this process typically involves multiple, separate steps. In one example, the transfer lamination involves metallizing a first side of a film and then bonding the metallized first side to a substrate. Then a coating is applied to a second side of the film after it has been bonded to the substrate. The bonded film and substrate are then placed in an oven. The film is then stripped from the substrate leaving metal from the film deposited on the substrate. The application of the coating is performed as an inline part of the transfer lamination process thereby providing an ease of manufacture presently unknown.

In another example, the metallization step involves placing a coated film in a metallizer where metals are vacuum deposited on the coated film to form the metallized layer. Once the coated film has been metallized, it is bonded to the substrate. In this step, the coated and metallized layer is placed within a transfer lamination apparatus and the layer is bonded via pressurized bonding with the adhesive layer to the substrate. Once bonded, the film/substate typically are cured in an oven. In one example, the metallized layer and the substrate are bonded through pressure bonding using rollers, however, other means of bonding, whether pressurized or not, may be employed including the use of a pressurizing chamber instead of rollers.

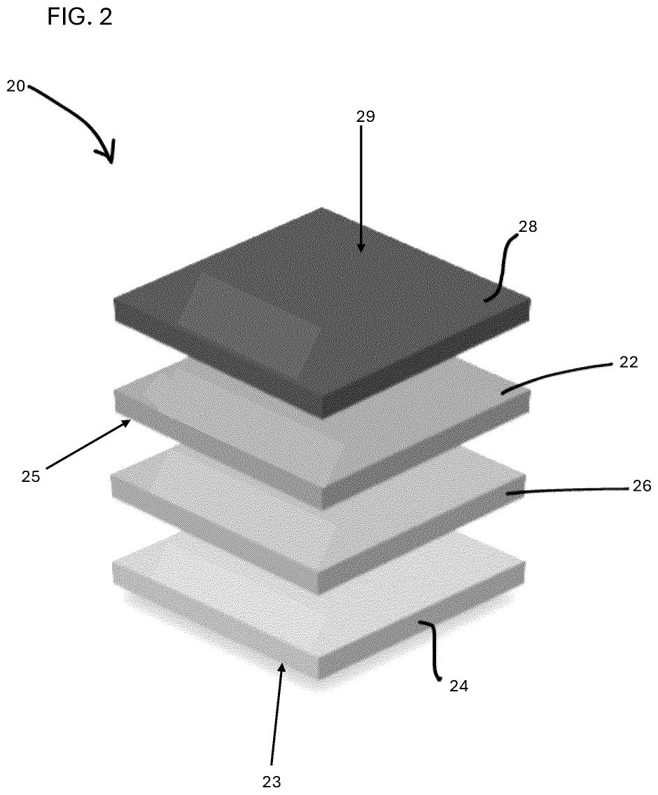

With reference to FIG. 2, a packaging construction 20 of a packaging assembly according to an embodiment of the present invention is illustrated. The packaging construction 20 of FIG. 2 is similar to the embodiment shown in FIG. 1, however, the layers are arranged in a different order compared to FIG. 1. The packaging construction 10 includes a base layer or substrate 22. A metallized layer 24 may be joined to an inside facing surface 25 of the base layer 12 by an adhesive layer 26. In one embodiment, a printable coating 28 is positioned adjacent to the base layer 22 and forms an outermost layer/surface 29 of the packaging assembly. The metallized layer 24 may form an innermost layer/surface 23 of the packaging assembly. In some embodiments, the metallized layer 24 may be a reflective metallized layer that may insulate an interior volume of the packaging assembly. In one example, the interior volume is configured to receive a plurality of beverage containers, preferably cold or cool beverage containers. The metallized layer 24 may reflect the cool or cold air from the beverage containers into the interior volume to maintain the cold or cool temperature of the beverage containers. In this way, the metallized layer 24 may insulate the contents (e.g., beverage containers) on the interior volume of the packaging assembly.

With respect to the metallized layer 24, such layer may be a vacuum metallized reflective layer, e.g., an aluminum vacuum metallized reflective layer. In an embodiment, the metallized reflective layer 14 may be applied to the substrate 12 using any technique known in the art, such as transfer lamination and the like.

In an embodiment, the adhesive layer 26 is a thermally-insulating adhesive having thermal insulating properties, although any adhesive known in the art may also be utilized even if it does not provide insulating properties (although insulating properties are desirable). The adhesive layer 26 may be heat activated, optically activated (e.g., UV light cured); or configured for attachment to the base layer 22 by mechanical means (e.g., “knurled” or textured together; or, flowing and freezing into textured surface crevices).

In another embodiment, a metallized layer is applied to both sides of the substrate via means hereinbefore disclosed (e.g., utilizing a thermally-insulating adhesive) such that when formed into a container or box, the metallized layer is present on the interior-facing surface of the container, as well as the exterior-facing surface of the container. In this respect, the inner metallized layer functions to reflect or keep the cold air within the interior space when moving the container from a chilled environment such as a refrigerator to ambient air in a car, home, or outdoors. In addition, the outer metallized layer functions to reflect sunlight and the warmer ambient air away from the container and interior space thereof, minimizing heat absorption and thus minimizing warming of the interior space and contents thereof. By utilizing the metallized layer on both the interior and exterior facing surfaces, dual effects can be achieved, providing an enhanced level of insulation for the interior space and products contained therein.

While the embodiments described above disclose the metallized layer as being an aluminum layer, the present invention is not intended to be limited in this regard. In particular, the interior, exterior, or both interior and exterior metallized layers (where utilized) may be formed from other metals such as, for example, silver. Accordingly, in one embodiment, the interior and/or exterior metallized layers are silver metallized layers.

In an embodiment, the printable coating 18/28 may be a heat resistant printable coating. For example, the heat resistant printable coating 18/28 may take the form of heat resistant coating/heat protection layer disclosed in U.S. Pat. No. 11,478,404, which is hereby incorporated by reference herein in its entirety. For example, in an embodiment, the heat resistant printable coating 18/28 may be transparent, translucent, tinted, or pigmented. In an exemplary embodiment, the heat resistant printable coating 18/28 may have a minimum thickness of about 0.8 microns (preferably, from about 0.8 to about 4.0 microns) and may be composed of a semi-crystalline polymer material (e.g., acrylic, polyester and polyurethane polymer materials) having a glass transition temperature (“T_{g}”) of greater than or equal to about 85° C., preferably having crystalline lamellae separated by amorphous regions. It is an important recognition of the present invention that controlling the ratio, composition, and nature of the crystalline lamellae (e.g., high turned, or tilt-angled), as compared to the amorphous regions, essentially controls the T_{g} of a particular polymer material. In other embodiments, the heat resistant printable coating is composed of a substantially homogeneous amorphous polymer material with a T_{g} of greater than or equal to about 85° C.

In an embodiment, the heat-resistant printable coating may include one or more holograms. In particular in an embodiment, the heat-resistant printable coating may be holographically embossed.

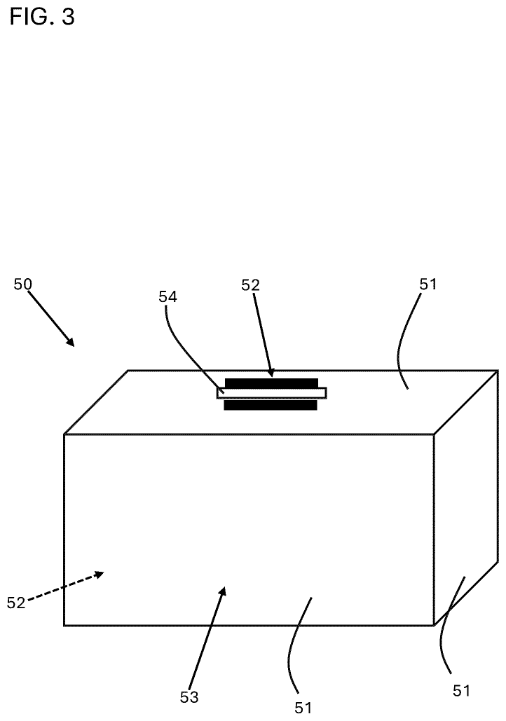

With reference to FIG. 3, the packaging construction 10 may be manufactured, cut and folded/formed to shape so as to form a packaging assembly 50 having an interior volume 52 for containing a plurality of beverage containers (e.g., glass bottles or aluminum cans). The packaging assembly 50 may have a plurality of walls 51 defining the interior volume 52 therebetween for receiving the plurality of beverage containers. The plurality of walls 51 have an interior side facing the interior volume 52 and an exterior side 53 facing an exterior. The packaging assembly may include a handle 54 for carrying.

As discussed above, in one example the packaging assembly 50 has, as its innermost layer, the substrate 12, and as its outermost layer, the printable coating 18. In an embodiment, the packaging assembly 50 may be formed to any desired shape or volume such as, for example, to hold 6, 12, 18, 24, 30 or 36 twelve ounce cans or bottles.

The packaging assembly 50 of the present invention has been shown to stabilize the interior temperature within the interior volume 52, and the contents within. As discussed above, the particular combination of the adhesive blend with thermal insulation properties, the vacuum metallized layer of aluminum for light reflectivity, and the heat resistant printable coating to paper or board for packaging applications has been shown to be able to keep liquid up to 30 degrees cooler after a full day in the sun as compared to existing paperboard beverage packaging. In particular, the packaging assembly 50 is formed from a substantially impermeable construction, keeping cold air within the interior volume 52 and reflecting solar rays.

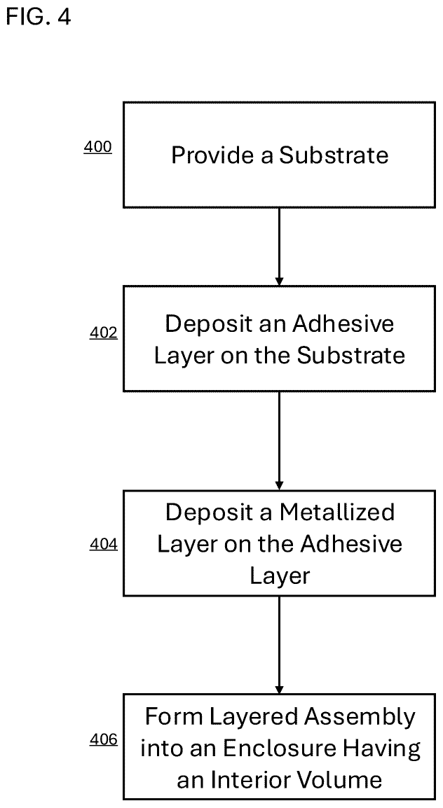

FIG. 4 shows a flowchart illustrating one example of a method 400 for forming a multi-layer packaging assembly. At step 402, the method may include providing a substrate or base layer.

At step 404, the method may include depositing an adhesive layer on the substrate. In one example, the adhesive layer may be a thermally-insulating adhesive having thermal insulating properties, although any adhesive known in the art may also be utilized even if it does not provide insulating properties (although insulating properties are desirable). The adhesive layer may be heat activated, optically activated (e.g., UV light cured); or configured for attachment to the substrate by mechanical means (e.g., “knurled” or textured together; or, flowing and freezing into textured surface crevices).

At step 406, the method may include depositing a metallized layer on the adhesive layer. The substrate, adhesive layer, and the metallized layer may form a layered assembly. At step 408, the method includes forming the layered assembly into an enclosure having an interior volume for receiving a plurality of beverage containers.

In other embodiments, the method may include an additional step of depositing a printable coating on an exterior layer. The printable coating may be a heat resistant printable coating. For example, the heat resistant printable coating may take the form of heat resistant coating/heat protection layer. For example, in an embodiment, the heat resistant printable coating may be transparent, translucent, tinted, or pigmented.

While the packaging assembly of the present invention has been described above in connection with maintaining a low temperature of packaged beverages and minimizing heat transfer from the ambient environment, it is not intended the present invention be so limited in this regard. In particular, it is contemplated that the packaging assembly 50 can be utilized for packaging any refrigerated or frozen food items. Moreover, it is contemplated that the packaging construction 10/20 and packaging assembly 50 of the present invention may be utilized to retain the heat of packaged food items (i.e., to minimize heat loss to the surrounding environment).

In one embodiment, a thermally-insulating packaging assembly is provided that includes an enclosure having a plurality of walls defining an interior volume therebetween for receiving a plurality of beverage containers. Each of the plurality of walls includes a substrate, an adhesive layer, and a metallized layer coupled to the substrate via the adhesive layer.

In one example, the thermally-insulating packaging assembly includes a heat resistant coating layer coupled to the metallized layer. The metallized layer may be positioned on an exterior of the packaging assembly and may be configured to reflect light away from the interior volume of the packaging assembly. In another example, the metallized layer may be positioned on an interior of the packaging assembly adjacent contents of the packaging assembly. The metallized layer may insulate the contents of the packaging assembly.

The metallized layer may contain aluminum. The base layer may contain one or both of a paperboard material or a cardboard material.

In one embodiment, a multi-layered packaging assembly is provided that includes a plurality of walls arranged to define an interior space. At least one of the plurality of interior walls includes a base layer, an insulating adhesive layer disposed atop the base layer, a metallized layer coupled to the base layer via the insulating adhesive layer, and a heat-resistant coating layer disposed atop the metallized layer.

In one example, the metallized layer is located on an outward-facing side of the base layer. The metallized layer may reflect light away from the interior space of the packaging assembly. In another example, the metallized layer is located on an inward-facing side of the base layer, adjacent contents of the packaging assembly. The metallized layer may insulate the contents of the packaging assembly.

In one embodiment, a method of forming a multi-layered packaging assembly is provided that includes providing a substrate, depositing an adhesive layer on the substrate, depositing a metallized layer on the adhesive layer. The substrate, the adhesive layer, and the metallized layer forming a layered assembly. The method may include forming the layered assembly into an enclosure having an interior volume for receiving a plurality of beverage containers.

In one example, the method further comprises applying a heat-resistant coating layer to the metallized layer. The method may include positioning the metallized layer on an exterior of the packaging assembly. The metallized layer may reflect light away from the interior volume of the packaging assembly. The metallized layer may be positioned on an interior of the packaging assembly adjacent contents of the packaging assembly. The metallized layer may insulate the contents of the packaging assembly. The metallized layer may be coupled with the base layer via transfer lamination.

Although this invention has been shown and described with respect to the detailed embodiments thereof, it will be understood by those of skill in the art that various changes may be made, and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the embodiments described herein are intended to define the parameters of the inventive subject matter, they are by no means limiting and are example embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

1. A thermally-insulating packaging assembly, comprising:
an enclosure having a plurality of walls defining an interior volume therebetween for receiving a plurality of beverage containers, each of the plurality of walls including:
a substrate;
an adhesive layer; and
a metallized layer coupled to the substrate via the adhesive layer.

2. The thermally-insulating packaging assembly of claim 1, further comprising a heat-resistant coating layer coupled to the metallized layer.

3. The thermally-insulating packaging assembly of claim 1, wherein the metallized layer is positioned on an exterior of the packaging assembly.

4. The thermally-insulating packaging assembly of claim 3, wherein the metallized layer is configured to reflect light away from the interior volume of the packaging assembly.

5. The thermally-insulating packaging assembly of claim 1, wherein the metallized layer is configured to be positioned on an interior of the packaging assembly adjacent contents of the packaging assembly.

6. The thermally-insulating packaging assembly of claim 5, wherein the metallized layer is configured to insulate the contents of the packaging assembly.

7. The thermally-insulating packaging assembly of claim 1, wherein the metallized layer contains aluminum.

8. The thermally-insulating packaging assembly of claim 1, wherein the base layer contains one or both of a paperboard material or a cardboard material.

9. A multi-layer packaging assembly, comprising:
a plurality of walls arranged to define an interior space, at least one of the plurality of walls including:
a base layer,
an insulating adhesive layer disposed atop the base layer,
a metallized layer coupled to the base layer via the insulating adhesive layer, and
a heat-resistant coating layer disposed atop the metallized layer.

10. The multi-layer packaging assembly of claim 9, wherein the metallized layer is located on an outward-facing side of the base layer.

11. The multi-layer packaging assembly of claim 10, wherein the metallized layer is configured to reflect light away from the interior space.

12. The multi-layer packaging assembly of claim 9, wherein the metallized layer located on an inward-facing side of the base layer.

13. The multi-layer packaging assembly of claim 12, wherein the metallized layer is configured to insulate the contents of the packaging assembly.

14. A method of forming a multi-layer packaging assembly, comprising:
providing a substrate;
depositing an adhesive layer on the substrate;
depositing a metallized layer on the adhesive layer, the substrate, adhesive layer and the metallized layer forming a layered assembly; and
forming the layered assembly into an enclosure having an interior volume for receiving a plurality of beverage containers.

15. The method of claim 14, further comprising applying a heat-resistant coating layer to the metallized layer.

16. The method of claim 14, further comprising positioning the metallized layer on an exterior of the packaging assembly.

17. The method of claim 16, wherein the metallized layer is configured to reflect light away from the interior volume of the packaging assembly.

18. The method of claim 14, further comprising positioning the metallized layer on an interior of the packaging assembly adjacent contents of the packaging assembly.

19. The method of claim 18, wherein the metallized layer is configured to insulate the contents of the packaging assembly.

20. The method of claim 14, wherein the metallized layer is coupled with the base layer via transfer lamination.
